(19) United States
(12) Patent Application Publication
(10) Pub. No.: US 2025/0306899 A1
(43) Pub. Date: Oct. 2, 2025

(54) SOFTWARE DELIVERY METHOD AND SOFTWARE DELIVERY SYSTEM

(71) Applicant: HONDA MOTOR CO., LTD., Tokyo (JP)

(72) Inventors: Hirofumi Segawa, Tokyo (JP); Tomoya Kitano, Tokyo (JP); Tetsushi Otaki, Tokyo (JP)

(21) Appl. No.: 19/054,229

(22) Filed: Feb. 14, 2025

(30) Foreign Application Priority Data
Mar. 26, 2024 (JP) 2024-048951

(51) Int. Cl. G06F 8/65; H04L 67/12; H04W 4/46

(52) U.S. Cl. CPC G06F 8/65; H04L 67/12; H04W 4/46

(57) ABSTRACT

A software delivery method of delivering software to a plurality of vehicles through wireless communication performed between each of the vehicles and a communication apparatus, includes: by a delivery management apparatus, identifying a target vehicle among the plurality of vehicles, the target vehicle being a target for which a delivery process of delivering the software is executed; determining a priority of each of the target vehicles for the delivery process by mapping relative positions of each of the target vehicles and the communication apparatus; and executing the delivery process for the target vehicles according to the priorities for the delivery process, wherein in the delivery process, the vehicle that is nearer to the communication apparatus than the target vehicle is assigned as a relay vehicle, and the software is transmitted from the relay vehicle to the target vehicle.

### INCORPORATION BY REFERENCE

The present application claims priority under 35 U.S.C. § 119 to Japanese Patent Application No. 2024-048951 filed on Mar. 26, 2024. The content of the application is incorporated herein by reference in its entirety.

### BACKGROUND OF THE INVENTION

### Field of the Invention

The present invention relates to a software delivery method and a software delivery system.

### Description of the Related Art

In recent years, research and development that contributes to more energy efficiency has been conducted in order to ensure that more people can gain access to affordable, reliable, sustainable, and advanced energy. For example, Japanese Patent Laid-Open No. 2018-005894 discloses a technology in which, in a system where vehicles equipped with onboard control devices are caused to download an update program, order of priority is determined based on a vehicle usage situation or the like.

Incidentally, a technology of delivering software to vehicles has the problem that when there are many target vehicles for which a process of delivering software is executed, communication congestion is caused, and it takes a long time to deliver software. If the time required to deliver software is long, the necessity arises to keep the vehicles activated for a long time, which is undesirable in terms of pursuing more energy efficiency.

To solve the problem, an object of the present application is to efficiently deliver software to a plurality of vehicles. The present application, in turn, contributes to more energy efficiency.

### SUMMARY OF THE INVENTION

An aspect of the present disclosure is a software delivery method of delivering software to a plurality of vehicles through wireless communication performed between each of the vehicles and a communication apparatus, the software delivery method including: by a delivery management apparatus, identifying a target vehicle among the plurality of vehicles, the target vehicle being a target for which a delivery process of delivering the software is executed; determining a priority of each of the target vehicles for the delivery process by mapping a relative relation between each of the target vehicles and the communication apparatus; and executing the delivery process for the target vehicles according to the priorities for the delivery process, wherein in the delivery process, the vehicle that is nearer to the communication apparatus than the target vehicle is assigned as a relay vehicle, and the software is transmitted from the relay vehicle to the target vehicle.

Another aspect of the present disclosure is a software delivery system that delivers software to a plurality of vehicles by causing, through control by a delivery management apparatus, each of the vehicles and a communication apparatus to perform wireless communication, wherein the delivery management apparatus performs: identifying a target vehicle among the plurality of vehicles, the target vehicle being a target for which a delivery process of delivering the software is executed; determining a priority of each of the target vehicles for the delivery process by mapping a relative relation between each of the target vehicles and the communication apparatus; and executing the delivery process for the target vehicles according to the priorities for the delivery process, and in the delivery process, the vehicle that is nearer to the communication apparatus than the target vehicle is assigned as a relay vehicle, and the software is transmitted from the relay vehicle to the target vehicle.

According to the aspects of the present disclosure, the delivery process of delivering software from the communication apparatus to the plurality of vehicles can be efficiently executed based on the positions of the communication apparatus and each vehicle, and more energy efficiency can be achieved.

### BRIEF DESCRIPTION OF THE DRAWINGS

FIG. 1 shows an example of a configuration of a software delivery system;

FIG. 2 shows a configuration of a vehicle;

FIG. 3 is a schematic diagram showing an example of mapping; and

FIG. 4 is a flowchart showing an example of operation of the software delivery system.

### DETAILED DESCRIPTION OF THE INVENTION

Hereinafter, an embodiment of the present invention is described with reference to the drawings.

### 1. Configuration of Software Delivery System

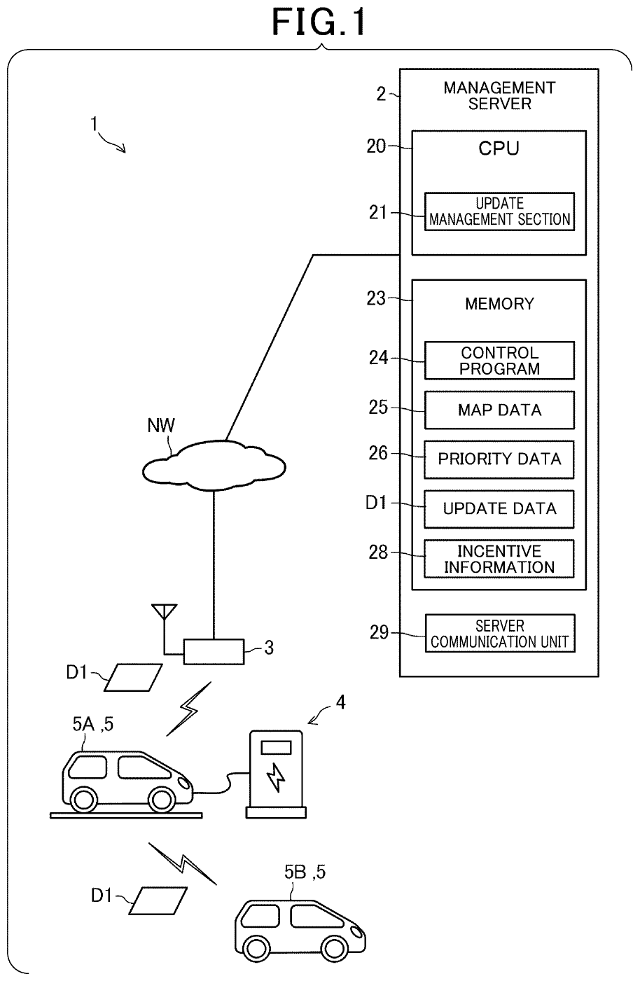

FIG. 1 shows a configuration of a software delivery system 1.

The software delivery system 1 is a system that, by using a wireless communication function of a vehicle 5, updates software that causes equipment mounted in the vehicle 5 to operate. Here, updating of software refers to a process of replacing software that is executed by a processor with a newer version of the software, and a specific aspect thereof may be any of adding, deleting, and overwriting of software. Processes of deleting part or the entire of the software that is executed by the processor, installing new software, and deleting, adding, and overwriting data used when the software is executed can also be included in updating of software. In the following description, software includes a program that is executed by the processor and data that is referred to, generated, updated, deleted, or the like in connection with the program, and includes firmware.

The software delivery system 1 can perform updating of software, for a plurality of vehicles 5. Although FIG. 1 shows vehicles 5A and 5B, the number of vehicles 5 that are targets of the process in the software delivery system 1 is not limited. Individual vehicles 5 including the vehicles 5A, 5B are expressed as “vehicle 5” when a distinction is not made among the individual vehicles 5. The vehicle 5 may be any one of a four-wheel vehicle, a two-wheel vehicle, and any other vehicle, and may be a large-sized vehicle, a commercial vehicle, a service vehicle, or the like.

The software delivery system 1 includes a communication apparatus 3 that performs wireless communication with the vehicle 5. The communication apparatus 3 is an apparatus such as a base station for cellular communication, a Wi-Fi® access point, or a Wi-Fi router. The communication apparatus 3 can perform wireless communication with a plurality of vehicles 5. The communication apparatus 3 is connected to a communication network NW through a wired communication line or a wireless communication link. A specific form of the communication network NW is not limited. The communication network NW may include, for example, a cellular communication network, the Internet, a WAN (Wide Area Network), a LAN (Local Area Network), a public circuit network, a provider apparatus, a dedicated line, a base station, and the like.

The communication apparatus 3 can perform wireless communication with a plurality of vehicles 5. The communication apparatus 3 performs communication with a management server 2 through the communication network NW. With such functions, the management server 2 can perform data communication with the vehicles 5 via the communication apparatus 3, which will be described later.

The vehicle 5 performs wireless communication based on cellular communication, Wi-Fi, Bluetooth®, or the like with the communication apparatus 3. Moreover, the vehicle 5 can perform wireless communication with another vehicle 5. For example, the vehicle 5B may perform communication with the communication apparatus 3, and may perform communication with the vehicle 5A.

Data that is used to update software in the vehicle 5 is referred to as update data D1. The update data D1 contains at least any one of a program and data, and includes, for example, a new version of a program, added data, data designating a program or data to be deleted, data related to update-target equipment, and the like. A process of delivering the update data D1 to the vehicle 5 is referred to as a delivery process. The updating of software in the vehicle 5 includes the delivery process, and an updating process of updating the software in the vehicle 5 based on the update data D1 delivered to the vehicle 5 through the delivery process.

In the software delivery system 1, a path of delivering the update data D1 to the vehicle 5 starts from the management server 2 and passes the communication network NW and the communication apparatus 3. Such cases include a case where the update data D1 is directly delivered from the communication apparatus 3 to the vehicle 5, and a case where the update data D1 that is delivered from the communication apparatus 3 to the vehicle 5 is further delivered to another vehicle 5. For example, the update data D1 for updating software in the vehicle 5B is delivered from the vehicle 5A to the vehicle 5B, in some cases.

The management server 2 is a computer communicably connected to the vehicle 5 via the communication network NW. The management server 2 manages the process of updating software in the vehicle 5. For example, when software in a plurality of vehicles 5 is to be updated, the management server 2 determines a priority of each of the vehicles 5. The management server 2 executes a process or the like of acquiring information required to determine priorities from the vehicles 5. For example, the management server 2 is implemented by one or more servers deployed on a network, such as the Internet, or a cloud server.

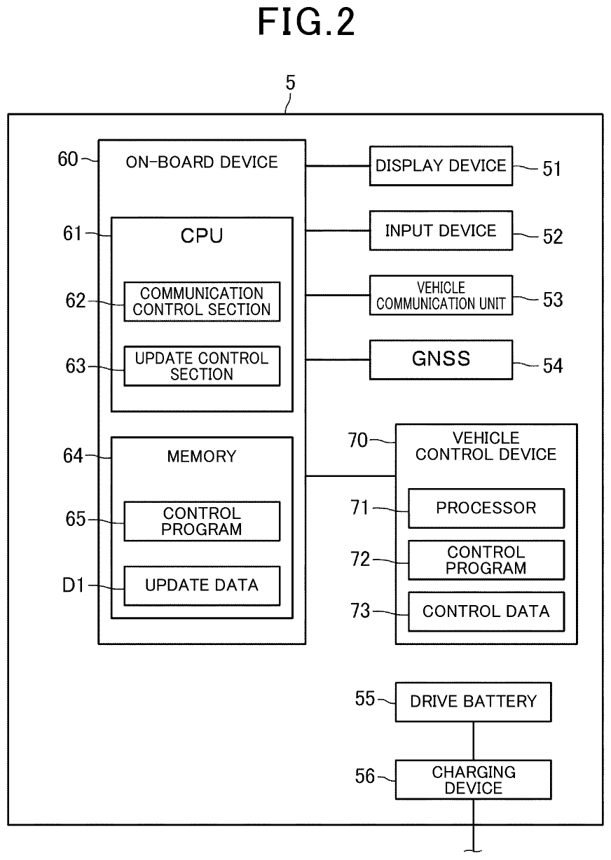

The software delivery system 1 may include a charging station 4. The charging station 4 includes an apparatus that charges a drive battery 55 (FIG. 2) mounted on the vehicle 5. In the software delivery system 1, the vehicle 5 that is charging at the charging station 4 can perform communication with another vehicle 5 and the management server 2.

### 2. Configuration of Management Server

As shown in FIG. 1, the management server 2 includes a CPU (Central Processing Unit) 20, a memory 23, and a server communication unit 29.

The memory 23 is a non-volatile storage device configured by using a magnetic storage medium or a semiconductor storage device, and stores a program to be executed by the CPU 20 and data. For example, the memory 23 stores a control program 24, map data 25, priority data 26, the update data D1, and incentive information 28.

The server communication unit 29 performs data communication via the communication network NW, according to control by the CPU 20. The server communication unit 29 is, for example, a communication interface that performs wired communication using a LAN, a WAN, a public circuit network, or the like through an Ethernet® cable, and includes a transmitter and a receiver. The server communication unit 29 may be a wireless communication interface including an antenna, a transmitter, and a receiver.

The CPU 20 manages updating of software in the vehicle 5 by reading and executing the control program 24 stored in the memory 23. Such a management function is assumed to be an update management section 21.

The update management section 21 performs communication with a plurality of vehicles 5 via the communication network NW and the communication apparatus 3, and acquires position information on each vehicle 5 and information related to a version and the like of software included in each vehicle 5. The update management section 21 creates the map data 25 by mapping a relative relation between each vehicle 5 and the communication apparatus 3. The map data 25 created by the update management section 21 is stored in the memory 23. Details of the map data 25 will be described later.

For each of the vehicles 5, the update management section 21 determines a priority for executing the delivery process, based on the map data 25. The update management section 21 generates the priority data 26 indicating the determined priorities and stores the priority data 26 in the memory 23.

The update management section 21 executes the delivery process, according to the priority data 26. In the delivery process, the update data D1 stored in the memory 23 is transmitted to the vehicle 5 via the communication network NW and the communication apparatus 3. Moreover, in the delivery process, the update management section 21 can cause the update data D1 transmitted from the communication apparatus 3 to the vehicle 5 to be transmitted from the vehicle 5 to another vehicle 5. In such a case, the vehicle 5 that has received the update data D1 from the communication apparatus 3 functions as a relay vehicle that relays the update data D1. Moreover, in the delivery process, when any vehicle 5 already has the update data D1, the management server 2 causes such a vehicle 5 to transmit the update data D1 to another vehicle 5. In such a case as well, the vehicle 5 that transmits the update data D1 functions as a relay vehicle.

After executing the delivery process, the update management section 21 generates the incentive information 28 associated with the vehicle 5 that was involved in the delivery process as a relay vehicle. The incentive information 28 is information indicating that an incentive is given to an owner or a user of the vehicle 5. The incentive is, for example, a discount on a price for charging of the vehicle 5 at the charging station 4.

### 3. Configuration of Vehicle

FIG. 2 shows a configuration of the vehicle 5.

The vehicle 5 includes an on-board device 60. The on-board device 60 includes a CPU 61 and a memory 64, and executes a process related to updating of software in the vehicle 5.

A display device 51, an input device 52, a vehicle communication unit 53, a GNSS (Global Navigation Satellite System) 54, and a vehicle control device 70 included in the vehicle 5 are connected to the on-board device 60. The display device 51 includes a liquid crystal display panel or an organic EL (Electro Luminescence) panel and displays a character and an image. The input device 52 receives an operation performed by an occupant of the vehicle 5. For example, the display device 51 is a liquid crystal display installed on a dashboard of the vehicle 5, and the input device 52 is a touch screen disposed, in a layered manner, on a display face of the display device 51.

The vehicle communication unit 53 is a wireless communication interface that includes an antenna, a transmitter, and a receiver and performs wireless communication with the communication apparatus 3 and another vehicle 5, according to control by the on-board device 60. For example, the vehicle communication unit 53 may be configured to perform communication in conformity with a wireless communication scheme, such as cellular communication, Wi-Fi, or Bluetooth. For example, the vehicle communication unit 53 may perform vehicle-to-vehicle communication based on a communication standard, such as DSRC (Dedicated Short Range Communications) or C-V2X (Cellular-V2X), with a wireless communication interface mounted in another vehicle 5. The vehicle communication unit 53 may perform wireless communication based on wide area wireless communication or short-range wireless communication with the communication apparatus 3.

The GNSS 54 determines the position of the vehicle 5 by receiving a wireless signal transmitted from a satellite.

The vehicle control device 70 is a device that controls equipment mounted in the vehicle 5. The equipment to be controlled by the vehicle control device 70 includes, for example, an internal combustion engine or a motor serving as a drive source of the vehicle 5, a brake system, a steering system, a lighting system, an autonomous driving system, a driving assistance system, a car navigation system, and the like. Although one vehicle control device 70 is depicted in FIG. 2, the vehicle 5 may include a vehicle control device 70 for each piece of equipment to be controlled, and the number of vehicle control devices 70 is not limited. Each vehicle control device 70 may have a configuration adapted to the equipment to be controlled by the vehicle control device 70.

The vehicle control device 70 includes a processor 71. The processor 71 is configured by using a CPU, an MPU (Micro Processor Unit), or the like, and is a so-called ECU (Electronic Control Unit). The processor 71 performs monitoring and control of the equipment be controlled, by executing a control program 72. When executing the control program 72, the processor 71 refers to control data 73 prepared for control of the equipment.

The vehicle 5 is equipped with the drive battery 55. The drive battery 55 is a rechargeable secondary battery and supplies electricity to the undepicted motor that is the drive source of the vehicle 5. The drive battery 55 supplies electricity to each part of the vehicle 5, including the on-board device 60. Thus, in the vehicle 5 in a state of not traveling, electricity can be supplied from the drive battery 55 to each part including the on-board device 60, which thus can be caused to operate.

A charging device 56 is connected to the drive battery 55. The charging device 56, in a state of being connected to the charging station 4, charges the drive battery 55 with electricity supplied from the charging station 4. The on-board device 60 can detect a state of charge, including the amount of electricity remaining in the drive battery 55 and whether or not the drive battery 55 is being charged by the charging device 56.

The memory 64 included in the on-board device 60 is a non-volatile storage device configured by using a magnetic storage medium or a semiconductor storage device, and stores a program to be executed by the CPU 61 and data. The memory 64 stores, for example, a control program 65 and the update data D1.

The CPU 61 executes a process related to updating of software of the vehicle control device 70 by reading and executing the control program 65. The CPU 61 functions as a communication control section regarding a communication control 62 and as an update control section 63 regarding an update control. When the delivery process is executed in the software delivery system 1, the CPU 61, in response to a request from the communication apparatus 3, generates update information on the vehicle 5 and transmits the update information to the communication apparatus 3. The update information includes identification information on the vehicle 5 and information related to a program and data to be subjected to the delivery process and the updating process in the vehicle 5. For example, the information related to a program and data to be subjected to the delivery process and the updating process includes the types, versions, the date and time of previous updating, and the like of the control program 72 and the control data 73 included in the vehicle 5.

In the delivery process, the CPU 61 receives the update data D1 from the communication apparatus 3 or another vehicle 5 and stores the update data D1 in the memory 64. The CPU 61 executes the updating process by using the update data D1 stored in the memory 64 and updates the control program 72 and the control data 73.

In the delivery process, when an instruction to transmit the update data D1 stored in the memory 64 to another vehicle 5 is received, the CPU 61 transmits the update data D1, according to the received instruction.

### 4. Example of Mapping

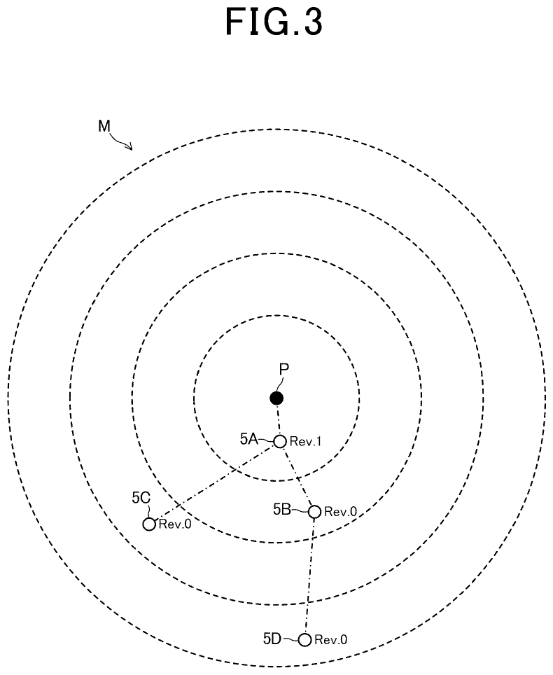

FIG. 3 is a schematic diagram showing an example of mapping that is performed by the update management section 21.

In a map M, a vehicle 5 that can communicate with the management server 2 is placed around a position P of the communication apparatus 3 that is centered. In the example in FIG. 3, four vehicles 5A, 5B, 5C, 5D are placed in the map M.

The map M is, for example, a two-dimensional map indicating the relative positions of each vehicle 5 and the communication apparatus 3. The update management section 21 acquires position information from the vehicles 5 that can communicate with the management server 2, and maps the position of each vehicle 5, with the position P centered. Based on the map M, the update management section 21 determines priorities of the plurality of vehicles 5 for the delivery process. For example, the update management section 21 determines the priorities in order from farthest from the position P to nearest thereto. In such a case, in the example in FIG. 3, the priority of the vehicle 5D is the highest, and the following priories are determined in the order of the vehicle 5C, the vehicle 5B, the vehicle 5A.

The update management section 21 may determine a vehicle 5 to be used for a relay vehicle, based on the map M. For example, when the delivery process is executed for the vehicle 5D, communication can be performed in a better communication state by using the vehicles 5A and 5B for relay vehicles, than by the vehicle 5D directly communicating with the communication apparatus 3. Similarly, when the delivery process is executed for the vehicle 5C, software can be delivered in a good communication state by using the vehicle 5A for a relay vehicle.

The update management section 21 may determine a target vehicle 5 of the delivery process, based on a version of software in each vehicle 5. The version of software refers to, for example, a version of a program and data stored in each vehicle 5. The version of software is included in update information that each vehicle 5 transmits to the management server 2. For example, the update management section 21 can determine the priorities by placing a higher priority on a vehicle 5 that has an older version of software. The update management section 21 may exclude a vehicle 5 that does not need to update software, from the targets of the delivery process.

The map M is not limited to a map on which two-dimensional mapping is performed as shown in FIG. 3. For example, the map M may be one-dimensional data in which the distance between each vehicle 5 and the communication apparatus 3 is mapped.

The map M may be data in which a vehicle 5 is mapped by using an indicator that is different from distance or position. The map M may be one-dimensional data in which the communication state between each vehicle 5 and the communication apparatus 3 is mapped. The communication state is, for example, a received strength (RSSI: Received Signal Strength Indicator), at a vehicle 5, of a wireless signal used for communication between the communication apparatus 3 and the vehicle 5.

### 5. Operation of Software Delivery System

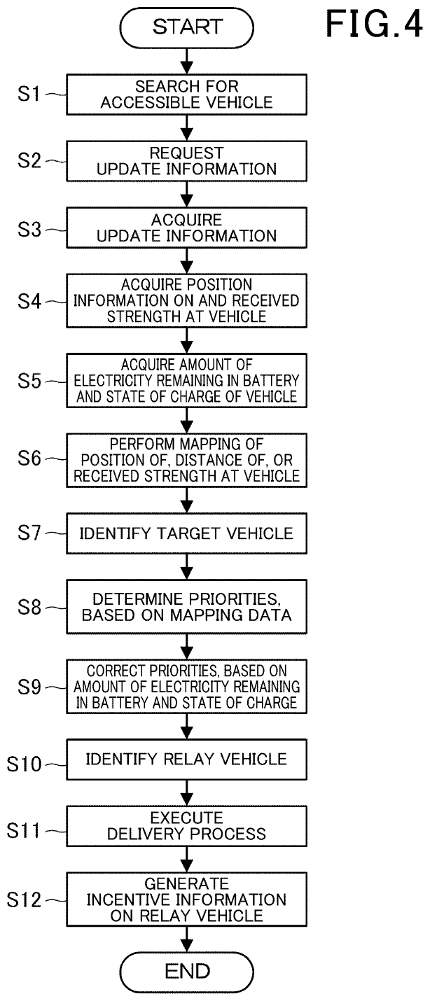

FIG. 4 is a flowchart showing operation of the software delivery system 1. Steps S1 to S12 in FIG. 4 are executed by the update management section 21. The operation in FIG. 4 is an example of a software delivery method of the present disclosure.

The management server 2 searches for an accessible vehicle 5 that can communicate with the management server 2 (step S1), and requests that the accessible vehicle 5 transmit update information (step S2). The management server 2 acquires the update information that is transmitted by the vehicle 5 in response to the request in step S2 (step S3).

The management server 2 further acquires, from each accessible vehicle 5, at least any one of the position information on and the received strength at the vehicle 5 (step S4). The management server 2 acquires, from each accessible vehicle 5, the amount of electricity remaining in the battery and the state of charge of the vehicle 5 (step S5). In steps S4 and S5, the management server 2 requests that each accessible vehicle 5 that can communicate with the management server 2 transmit information, and acquires the information transmitted by each vehicle 5 in response to the request.

The management server 2 performs mapping based on the position information on or the received strength at each vehicle 5 acquired in step S4 (step S6). In step S6, the management server 2 performs mapping based on any of the relative positions of each vehicle 5 and the communication apparatus 3, the distance between each vehicle 5 and the communication apparatus 3, and the received strength at each vehicle 5.

The management server 2 identifies a target vehicle for which the delivery process is executed, based on the update information acquired in step S3 (step S7). In other words, the management server 2 selects, among the accessible vehicles 5 that can communicate with the management server 2, a vehicle 5 that has a version of software needing an update, as a target vehicle.

Based on a result of the mapping in step S6, the management server 2 determines priorities of a plurality of vehicles 5 selected as target vehicles (step S8). For example, the management server 2 determines the priorities of the vehicles 5 in order of distance from the communication apparatus 3 from greatest to shortest. For example, the management server 2 determines the priorities of the vehicles 5 in order of communication state with the communication apparatus 3 from worst to best. Note that a vehicle 5 that is not selected as a target vehicle in step S7 is not a target of the delivery process and is therefore exempt from the process in step S8.

The management server 2 corrects the priorities determined in step S8, based on the amount of electricity remaining in the battery and the state of charge of each vehicle 5 of which the priority is determined (step S9). For example, the management server 2 makes the priority of a vehicle 5 that has a smaller amount of electricity remaining in the battery higher than the priorities of the other vehicles 5. Specifically, the management server 2 corrects the priority of a vehicle 5 that has a smaller amount of electricity remaining in the battery than a preset threshold value, to the highest of the priorities of all target vehicles. At the time, when there is a plurality of vehicles 5 that has a smaller amount of electricity remaining in the battery than the threshold value, the management server 2 determines the priorities of such vehicles 5 in order of the amount of electricity remaining in the battery from smallest to largest. In step S9, the management server 2 may exclude a vehicle 5 that is charging the drive battery 55 from the target vehicles, or may correct the priority of the vehicle 5 that is charging, to the lowest of the priorities of all target vehicles.

The management server 2 identifies a vehicle 5 to be used for a relay vehicle in the delivery process (step S10). For example, based on the result of the mapping in step S6, or the position information acquired in step S4, the management server 2 identifies a vehicle 5 to be used for a relay vehicle when executing the delivery process for a vehicle 5 that is far from the communication apparatus 3. Here, the management server 2 may preferentially identify, as a relay vehicle, a vehicle 5 that is charging at the charging station 4. The relay vehicle remains activated while the delivery process is executed. The vehicle 5 that is charging at the charging station 4 is preferable, without causing concern that excessive exhaustion of the drive battery 55 will result due to the vehicle 5 operating as a relay vehicle.

The management server 2 executes the delivery process for each vehicle 5, according to the priorities corrected in step S9, using the relay vehicle determined in step S10 (step S11). Here, the management server 2 may execute the delivery process for the plurality of vehicles 5 in parallel.

The management server 2 generates, and stores in the memory 23, incentive information 28 related to the vehicle 5 used for a relay vehicle in the delivery process.

The software delivery system 1 can efficiently execute the process of updating software in a plurality of vehicles 5. The software delivery system 1 is particularly preferable when a plurality of vehicles 5 updates software through communication via the communication apparatus 3, and when a large number of vehicles 5, compared to the communication apparatus 3, connect to the communication apparatus 3. For example, when a large number of vehicles 5 perform communication for updating software individually via the communication apparatus 3, communication traffic rapidly increases between the vehicles 5 and the communication apparatus 3 and between the communication apparatus 3 and the communication network NW, resulting in the communication band being congested. Accordingly, there is concern that it takes a long time for each vehicle 5 to download the update data D1. Each vehicle 5 operates with energy from an internal combustion engine or the drive battery 55 that are the drive sources, for a period from start until completion of the download of the update data D1, and also during the updating process of updating the control program 72 and the like based on the update data D1. Accordingly, the fact that a long time is required for the download of the update data D1 and the updating process has the problem of poor energy efficiency. In addition, the fact that a large number of vehicles 5 each take a long time to download the update data D1 and execute the updating process causes concern about significant deterioration in the energy efficiency of the software delivery system 1 as a whole.

For example, a conceivable case is that a plurality of vehicles 5 is situated for a relatively long time in an environment where communication is impossible. Specifically, such cases are that a large number of vehicles 5 are transported by sea on a ship, and that a plurality of vehicles 5 is kept in an underground parking lot or the like. In such cases, when the vehicles 5 move to an environment where communication is possible, since the large number of vehicles 5 start communication via the communication apparatus 3 that is smaller in number than the vehicles 5, there arises concern about an event as described above. When, by applying the software delivery system 1 to such cases, priorities of the plurality of vehicles 5 for the delivery process are determined based on a relative relation between each vehicle 5 and the communication apparatus 3 and the delivery process is executed according to the priorities, it is possible to avoid a rapid change in communication traffic between the communication apparatus 3 and the communication network NW. Accordingly, time taken for one vehicle 5 to download the update data D1 is shortened, so that it is possible to reduce the time period for which each vehicle 5 remains activated to download the update data D1 and execute the updating process, and thus to greatly increase energy efficiency as a whole.

### 6. Other Embodiments

The above-described embodiment is only an aspect of embodying the present invention, and any modifications and applications can be made without departing from the gist of the present invention.

In the embodiment, the configuration is described in which the update management section 21 included in the management server 2 executes the processes of mapping the relative relation between each vehicle 5 and the communication apparatus 3 and determining priorities, which, however, is an example. A specific place where a functional section corresponding to the update management section 21 is disposed can be changed as appropriate. For example, any vehicle 5, the communication apparatus 3, a computer connected to the communication apparatus 3, or any other apparatus may be configured to execute the functionality of the update management section 21 and function as a delivery management apparatus.

FIGS. 1 and 2 are schematic diagrams showing the configurations of the management server 2 and the vehicle 5 that are segmented in order to facilitate the understanding of the invention of the present disclosure, and the scope of application of the present disclosure is not limited to the configurations shown in FIGS. 1 and 2. A process by each constituent element may be executed by one hardware unit, or may be executed by a plurality of hardware units. The processes shown in FIG. 4 may be executed based on one program, or may be executed based on a plurality of programs.

### 7. Configurations Supported by the Embodiments

The above-described embodiments support the following configurations.

(Configuration 1) A software delivery method of delivering software to a plurality of vehicles through wireless communication performed between each of the vehicles and a communication apparatus, the software delivery method including: by a delivery management apparatus, identifying a target vehicle among the plurality of vehicles, the target vehicle being a target for which a delivery process of delivering the software is executed; determining a priority of each of the target vehicles for the delivery process by mapping a relative relation between each of the target vehicles and the communication apparatus; and executing the delivery process for the target vehicles according to the priorities for the delivery process, wherein in the delivery process, the vehicle that is nearer to the communication apparatus than the target vehicle is assigned as a relay vehicle, and the software is transmitted from the relay vehicle to the target vehicle.

According to the software delivery method in configuration 1, it is possible to appropriately determine priorities for executing the delivery process for the plurality of vehicles, based on the relative relation between each vehicle and the communication apparatus, and to execute the delivery process. Thus, it is possible to curb a rapid increase in communication traffic in connection with the delivery process, to efficiently execute the delivery process for the plurality of vehicles, and to achieve more efficiency in energy consumption.

(Configuration 2) The software delivery method according to configuration 1, wherein the priority of each of the target vehicles for the delivery process is determined in such a manner that a higher priority is placed on the target vehicle that is farther from the communication apparatus.

According to the software delivery method in configuration 2, by placing a higher priority on a vehicle that is farther from the communication apparatus and executing the delivery process, it is possible to complete the delivery process for the plurality of vehicles more efficiently.

(Configuration 3) The software delivery method according to configuration 1, wherein the priority of each of the target vehicles for the delivery process is determined in such a manner that a higher priority is placed on the target vehicle that is in a poorer state of communication with the communication apparatus.

According to the software delivery method in configuration 3, by placing a higher priority on a vehicle that is in a poorer state of communication with the communication apparatus and executing the delivery process, it is possible to complete the delivery process for the plurality of vehicles more efficiently.

(Configuration 4) The software delivery method according to any one of configurations 1 to 3, wherein the priority of each of the target vehicles for the delivery process is determined in such a manner that a higher priority is placed on the target vehicle that has a smaller amount of electricity remaining in a battery mounted on the target vehicle.

According to the software delivery method in configuration 4, by placing a higher priority on a target vehicle that has a smaller amount of electricity remaining in the battery and executing the delivery process, it is possible to prevent the target vehicle from exhausting the battery in connection with the delivery process.

(Configuration 5) The software delivery method according to any one of configurations 1 to 4, wherein the target vehicle is equipped with a battery, and the priorities for the delivery process are determined in such a manner that a higher priority is placed on the target vehicle that is not charging the battery than the target vehicle that is charging the battery.

According to the software delivery method in configuration 5, by placing a higher priority on a target vehicle that it not charging the battery, it is possible to prevent the target vehicle from exhausting the battery in connection with the delivery process.

(Configuration 6) The software delivery method according to any one of configurations 1 to 5, further including, by the delivery management apparatus, generating incentive information indicating that an incentive is given to the relay vehicle, according to a state of executing the delivery process involving the relay vehicle.

According to the software delivery method in configuration 6, since an incentive is given to the owner or user of the relay vehicle, use of at least one of the vehicles for a relay vehicle in the delivery process is encouraged, so that it is possible to achieve even greater efficiency in energy consumption.

(Configuration 7) A software delivery system that delivers software to a plurality of vehicles by causing, through control by a delivery management apparatus, each of the vehicles and a communication apparatus to perform wireless communication, wherein the delivery management apparatus performs: identifying a target vehicle among the plurality of vehicles, the target vehicle being a target for which a delivery process of delivering the software is executed; determining a priority of each of the target vehicles for the delivery process by mapping a relative relation between each of the target vehicles and the communication apparatus; and executing the delivery process for the target vehicles according to the priorities for the delivery process, and in the delivery process, the vehicle that is nearer to the communication apparatus than the target vehicle is assigned as a relay vehicle, and the software is transmitted from the relay vehicle to the target vehicle.

According to the software delivery system in configuration 7, it is possible to appropriately determine priorities for executing the delivery process for the plurality of vehicles, based on the relative relation between each vehicle and the communication apparatus, and to execute the delivery process. Thus, it is possible to curb a rapid increase in communication traffic in connection with the delivery process, to efficiently execute the delivery process for the plurality of vehicles, and to achieve more efficiency in energy consumption.

(Configuration 8) The software delivery system according to configuration 7, including a charging unit that is able to charge a battery mounted on the relay vehicle.

According to the software delivery system in configuration 8, since charging of the relay vehicle can be performed during the delivery process, it is possible to dispel concern about consumption of the battery of the vehicle serving as a relay vehicle, and therefore to positively use the relay vehicle. Accordingly, it is possible to achieve even greater efficiency in energy consumption.

### REFERENCE SIGNS LIST

1 software delivery system, 2 management server (delivery management apparatus), 3 communication apparatus, 4 charging station (charging unit), 5, 5A, 5B, 5C, 5D vehicle, 20 CPU, 21 update management section, 23 memory, 24 control program, 25 map data, 26 priority data, 28 incentive information, 29 server communication unit, 52 input device, 53 vehicle communication unit, 54 GNSS, 55 drive battery, 56 charging device, 60 on-board device, 61 CPU, 64 memory, 65 control program, 70 vehicle control device, 71 processor, 72 control program, 73 control data, D1 update data, NW communication network.

1. A software delivery method of delivering software to a plurality of vehicles through wireless communication performed between each of the vehicles and a communication apparatus, the software delivery method comprising:
by a delivery management apparatus,
identifying a target vehicle among the plurality of vehicles, the target vehicle being a target for which a delivery process of delivering the software is executed;
determining a priority of each of the target vehicles for the delivery process by mapping a relative relation between each of the target vehicles and the communication apparatus; and
executing the delivery process for the target vehicles according to the priorities for the delivery process,
wherein in the delivery process, the vehicle that is nearer to the communication apparatus than the target vehicle is assigned as a relay vehicle, and the software is transmitted from the relay vehicle to the target vehicle.

2. The software delivery method according to claim 1, wherein the priority of each of the target vehicles for the delivery process is determined in such a manner that a higher priority is placed on the target vehicle that is farther from the communication apparatus.

3. The software delivery method according to claim 1, wherein the priority of each of the target vehicles for the delivery process is determined in such a manner that a higher priority is placed on the target vehicle that is in a poorer state of communication with the communication apparatus.

4. The software delivery method according to claim 1, wherein the priority of each of the target vehicles for the delivery process is determined in such a manner that a higher priority is placed on the target vehicle that has a smaller amount of electricity remaining in a battery mounted on the target vehicle.

5. The software delivery method according to claim 1, wherein the target vehicle is equipped with a battery, and
the priorities for the delivery process are determined in such a manner that a higher priority is placed on the target vehicle that is not charging the battery than the target vehicle that is charging the battery.

6. The software delivery method according to claim 1, further comprising, by the delivery management apparatus, generating incentive information indicating that an incentive is given to the relay vehicle, according to a state of executing the delivery process involving the relay vehicle.

7. A software delivery system that delivers software to a plurality of vehicles by causing, through control by a delivery management apparatus, each of the vehicles and a communication apparatus to perform wireless communication, wherein
the delivery management apparatus performs:
identifying a target vehicle among the plurality of vehicles, the target vehicle being a target for which a delivery process of delivering the software is executed;
determining a priority of each of the target vehicles for the delivery process by mapping a relative relation between each of the target vehicles and the communication apparatus; and
executing the delivery process for the target vehicles according to the priorities for the delivery process, and
in the delivery process, the vehicle that is nearer to the communication apparatus than the target vehicle is assigned as a relay vehicle, and the software is transmitted from the relay vehicle to the target vehicle.

8. The software delivery system according to claim 7, comprising a charging unit that is able to charge a battery mounted on the relay vehicle.
